(19) United States
(12) Patent Application Publication
(10) Pub. No.: US 2017/0314970 A1
(43) Pub. Date: Nov. 2, 2017

(54) RESET DEVICE FOR A TRANSMISSION SELECTOR LEVER

(71) Applicant: ZF Friedrichshafen AG, Friedrichshafen (DE)

(72) Inventors: Jorg Jahn, Bünde (DE); Joachim Degen, Schermbeck (DE)

(73) Assignee: ZF Friedrichshafen AG, Friedrichshafen (DE)

(21) Appl. No.: 15/318,214

(22) PCT Filed: May 22, 2015
(86) PCT No.: PCT/EP2015/061349

§ 371 Date: Dec. 12, 2016

(30) Foreign Application Priority Data
Jun. 13, 2014 (DE) DE102014211376.8
Jun. 24, 2014 (DE) DE102014212058.6

(51) Int. Cl. G01D 5/22; G01B 7/00; G01B 7/305; F16H 59/10; F16H 59/02

(52) U.S. Cl. CPC G01D 5/2241; F16H 59/105; G01B 7/003; F16H 59/0204; G01B 7/305; F16H 2059/0226; F16H 2059/0295

(57) ABSTRACT

A reset device for a gearshift lever for a gear step of a transmission in a motor vehicle comprises an electric drive device for controlling an operating element, in order to move the gearshift lever into a predetermined position, a position sensor for determining a position of the operating element, and an electric activation device for activating the drive device, depending on the position of the operating element. The position sensor comprises a first coil thereby, which is attached to the activation device, and a magnetic flux element is mechanically coupled to the operating element. The drive device is disposed in relation to the activation device, such that the flux element influences the inductivity of the first coil, depending on a position of the operating element.

The disclosure relates to a reset device for a gearshift lever in a motor vehicle. In particular, the disclosure relates to the sensing of a position of an element of the reset device.

A motor vehicle comprises a transmission having numerous gear steps. An operation of the transmission can be influenced by a driver of the motor vehicle by means of a gearshift lever. By way of example, a manual program can be selected, in which the driver must explicitly trigger a gear change of the transmission via the gearshift lever. Alternatively, an automatic program may be selected, in which a control device carries out the selection and engagement of gear steps in the transmission. The programs can likewise be selected by means of the gearshift lever. In order to be able to start the motor at the start of a drive, the automatic program must be preset. For this, the gearshift lever can be slid from the manual program into the automatic program at the position N during the previous parking of the vehicle for example. Furthermore, the same mechanism can lock the gearshift lever in place, and also prevent, for example, a tilting movement back into the manual program, depending on the operating state (e.g. ignition is off).

A reset device for engaging the automatic program comprises an actuator, the position of which must be detected in order to ensure that the resetting has been correctly and completely carried out, and that the reset mechanism has returned to its end position/starting position. Known sensors in the gearshift lever, which can be used to sense the position of the reset device, comprise switches or hall effect sensors. These elements are relatively expensive to manufacture, however, and may exhibit an increased failure probability, such that the reset device is less reliable.

JP 2008-256693 discloses an assembly having three flat, horizontally offset coils, which can be influenced by a rhombus-shaped eddy current element. As a result, the position of the element can be determined in relation to the coils, but the necessary circuitry and mechanical expenditure for determining the position is relatively high.

The object of the present disclosure is to provide a reset device having an improved position determination for a gearshift lever of a motor vehicle. The disclosure achieves this objective by means of a reset device having the features of the independent Claim. The dependent Claims describe preferred embodiments.

A reset device for a gearshift lever for a gear step of a transmission in a motor vehicle comprises an electric drive device for controlling an operating element in order to move the gearshift lever into a predetermined position, a position sensor for determining a position of the operating element, and an electric activation device for activating the drive device depending on the position of the operating element. The position sensor comprises a first coil thereby, which is attached to the activation device, and a magnetic flux element is mechanically coupled to the operating element. The drive device is disposed with respect to the activation device, such that the flux element affects the inductivity of the first coil depending on a position of the operating element.

Preferably, a dynamic magnetic field is generated by the first coil, which is affected by the flux element, such that the presence of the flux element in the region of the first coil can be determined based on an electrical parameter at the coil. In particular, the inductivity of the first coil can be increased or decreased, when the flux element is moved closer to the first coil.

By attaching the first coil directly to the activation device, costs can be reduced, and the reliability of the position sensor can be increased. The arriving at one or more end positions of the operating element can thus be easily and reliably detected with less effort. An installment and/or adjustment of the first coil can be carried out inexpensively.

The activation device preferably comprises a printed circuit board, wherein the first coil is designed as a conductive path on the printed circuit board, in particular a spiral conductive path. As a result, a separate coil is not necessary. With a reduced use of materials and production costs, the reset device can be produced in a less expensive manner. Furthermore, connection points can be eliminated, such that the reliability of the reset device can be increased. The coil can be more easily protected on the printed circuit board, for example, by means of a cover, such that it is not susceptible to moisture, corrosion and electrical contact.

In a preferred embodiment, the position sensor comprises a second coil, which is attached to the activation device such that its inductivity is not affected by a position of the operating element, wherein the position sensor is configured to determine the position of the operating element based on a difference in the inductivities of the coils. As a result, a differential determination of the position of the operating element can be carried out, which can offer a high degree of precision or reliability. A measurement principle of this type is described in EP 1 884 749 A1. By using this measurement principle for the reset device, a particularly inexpensive and reliable integrated solution can be created, which can ensure that the gearshift lever will be correctly reset.

In one embodiment, at least one other position sensor is provided for determining a position of a gearshift lever. The at least one other position sensor can function according to the same measurement principle in particular, wherein shared structural elements may be used in multiple instances. By way of example, the at least one other position sensor may comprise a third coil, the inductivity of which depends on the position of the gearshift lever, while the second coil is not affected by a position of the gearshift lever. The position of the gearshift lever is determined thereby based on a difference in the inductivities of the second and third coils.

By means of the multiple use of the second coil, the relative effort for determining the position of the operating element can be reduced. System costs for the reset device can thus be lowered. In particular in one embodiment, in which the coils are excited to electromagnetic oscillations independently of one another, the frequencies of which are numerically compared, a complementary influencing of the first and second coils, or an influencing of the second coil by one of the moving elements is practically eliminated. The determinations of the position can thus be carried out with limited effort, without reciprocity, and in a reliable manner.

In order to influence the inductivity of the first coil, the flux element is configured in different variations to amplify or reduce the magnetic field provided by the first coil when the flux element is brought closer to the first coil. As a result, the inductivity of the first coil can change accordingly. An amplification or reduction by a predetermined factor, or beyond a predetermined threshold value, can be used for determining the presence or absence of the flux element at the coil, such that a binary result can be obtained, in the manner of a switch. If the flux element comprises a section having a magnetically soft substance, then this section can amplify the magnetic flux in the region of the first coil, when it is brought into the proximity of the first coil, and thus increase the inductivity of the first coil. If the flux element comprises, on the other hand, a section having an electrically conductive material, the magnetic field or the magnetic flux in the region of the first coil can be reduced when the section is brought into the proximity of the first coil. The inductivity of the first coil decreases thereby. The conductive material is preferably not ferromagnetic, e.g. copper, aluminum, or gold or another highly conductive metal may be used, potentially also in the form of an alloy.

Both variations can each be implemented in a cost-effective manner, independently of one another. The magnetically soft substance can comprise, e.g., ferrite, soft iron, an iron alloy or a special magnetically soft material such as Mu-metal. Fundamentally, the material requires good high-frequency properties. For this, the conductivity and the cyclic magnetization losses of the material must be low, but the permeability must be high. In one embodiment, the conductive material is attached to the operating element as a separate flux element. In another embodiment, the operating element comprises a section made of conductive material, which can be used as a flux element.

In order to determine the position, an arrangement of numerous sections of flux elements may be provided, wherein each section can comprise a magnetically soft substance, an electrically conductive material, or a material that leaves the inductivity of the first coil unaffected. The last of these can be implemented, in particular, by means of an appropriate cavity, or boundary of the flux element.

The sections can be moved past the first coil successively, when the operating element is operated, wherein the position of the operating element is determined incrementally, based on a temporal course of inductions at the first coil. The principle of a digital incremental encoder can thus be applied to the determination of the position of the operating element. As a result, a high position resolution of the operating element can be determined with limited effort.

In another embodiment, numerous first coils are provided, wherein the arrangement is moved past the first coils when the operating element is operated. The position of the operating element is determined absolutely thereby, based on a combination of inductions of the first coil. The position of the operating element can be digitally encoded through the position of the sections in relation to the first coil, such that a high determination precision of the position of the operating element can be obtained. In yet another embodiment, two flux elements are provided, which lie opposite one another with respect to the printed circuit board. As a result, the affect on the first coil attached to the printed circuit board can be amplified by the two flux elements.

In yet another embodiment, two first coils are provided, which lie on different planes of the printed circuit board. The first coils can be electrically interconnected, for example, by means of interlayer connections, in particular electrically in series. As a result, the two first coils can be regarded as a first coil having an increased number of windings. In this manner, the inductivity of the entire coil can be more easily changed by the flux element.

The disclosure shall now be explained in greater detail with reference to the attached Figures, wherein:

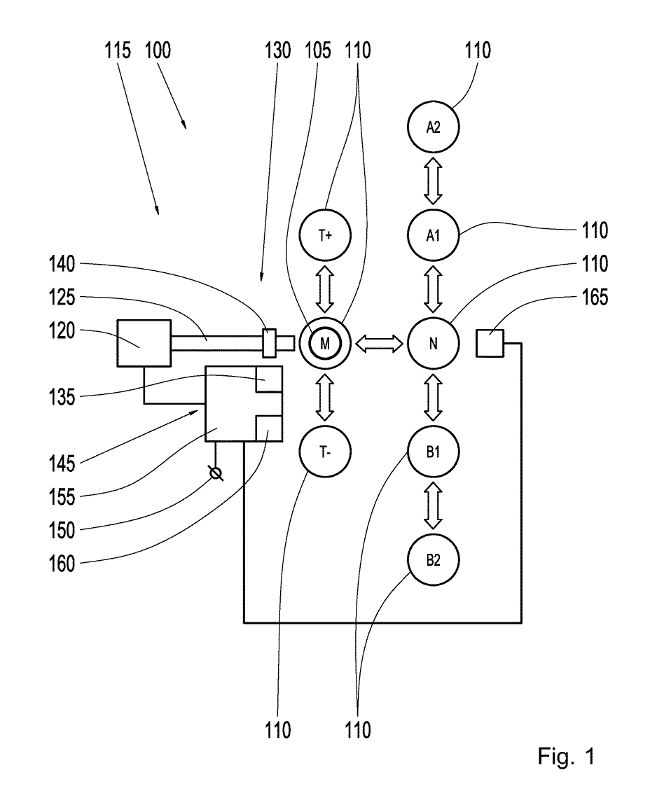

FIG. 1 shows a control system;

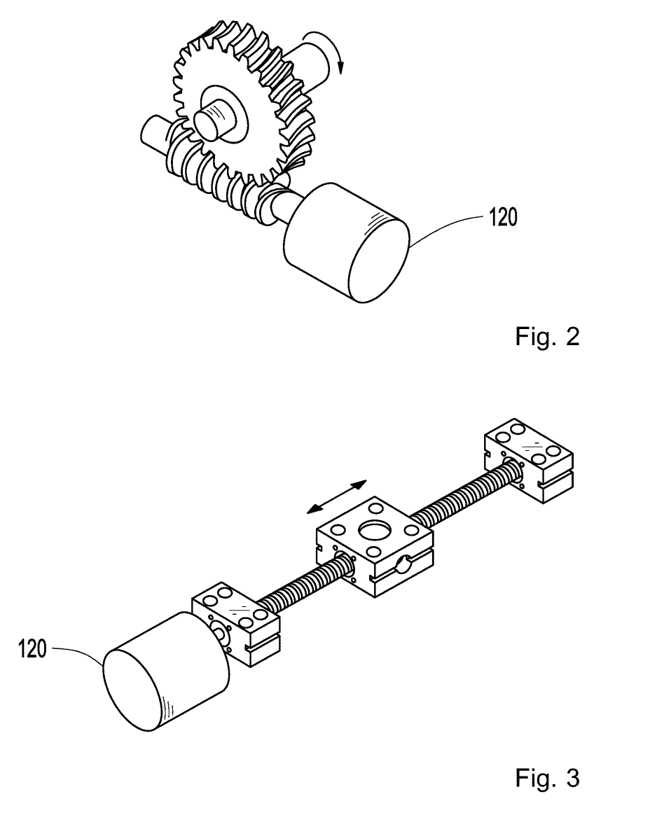

FIGS. 2-3 show two exemplary mechanical drives;

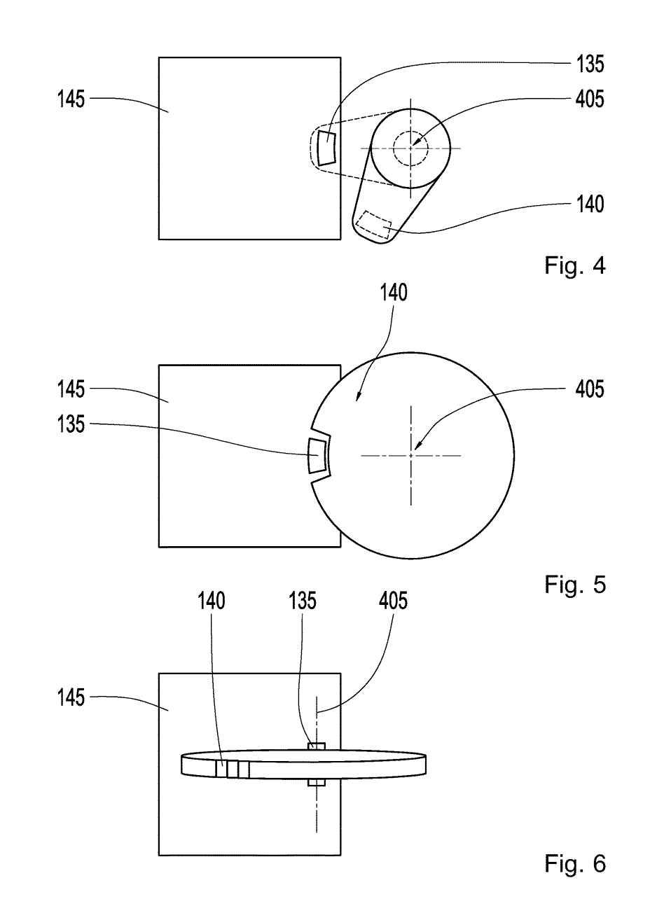

FIGS. 4-6 show variations of an assembly for a mechanical drive on the activation device of the reset device from FIG. 1; and

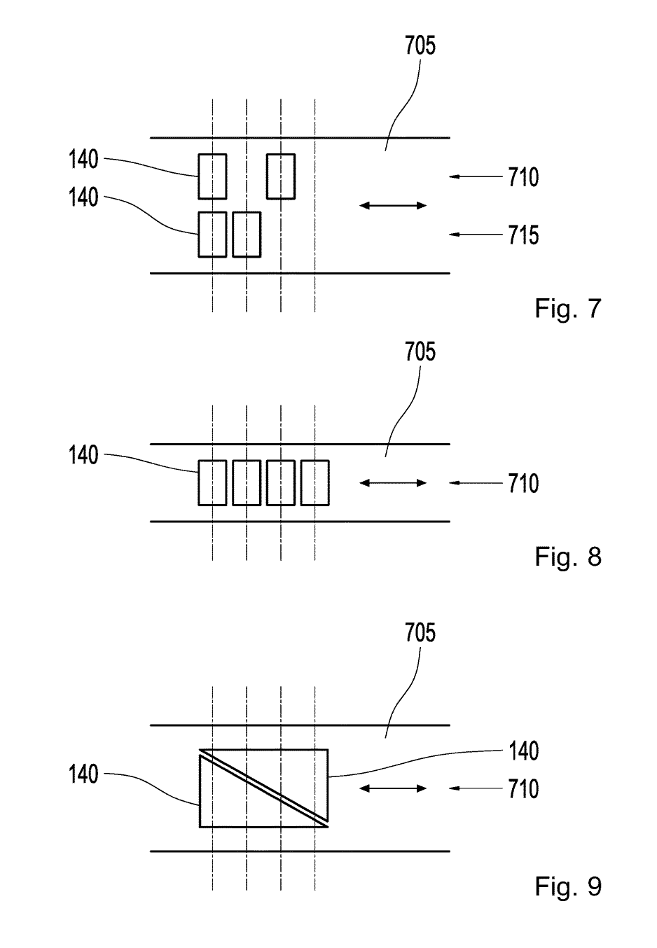

FIGS. 7-9 show arrangements of flux elements.

FIG. 1 shows a control system 100 for controlling a transmission in a motor vehicle. By means of a gearshift lever 105 mounted in a monostable manner, a gear step of the transmission can be selected directly or indirectly. For this, the gearshift lever 105 can be brought into different positions 110. In the embodiment depicted by way of example, the positions A1, A2, B1 and B2 are depicted vertically in a right-hand shift gate, which corresponds to an automatic gate for an automatic transmission. Likewise, the position N lies in the right-hand region, which corresponds to a neutral setting of the gearshift lever, into which the gearshift lever automatically returns, due to its monostable mount, in order to assume its starting position, which corresponds to an un-actuated gearshift lever position. It is possible to select at least the gear steps D for forward driving, N for the neutral setting of the transmission, and R for reverse driving though shifting movements in the automatic gate, wherein the gear steps D and R are separated from one another by the gear step N. Other selectable gear steps are possible in the automatic gate. The position A1 represents a forward change from one gear step to the next in this preferred exemplary embodiment, in the sequence of the arrangement of the gear steps, wherein A2 enables a forward change from one gear step to the gear step after the next, by shifting through the gear step lying therebetween. B1 represents a reverse shifting, accordingly, from one gear step to the next, wherein B2 enables a reverse shifting from one gear step to the step after the next, by shifting through the gear step lying therebetween, in the sequence of the arrangement of the gear steps. By way of example, gear steps may be provided, arranged in the sequence R, N, D, wherein the automatic transmission can be shifted into the gear step R, for example. A selection of the position A1 then causes a shifting from the gear step R into the gear step N. The selection of the position A2, in contrast, causes a shifting form the gear step R, via the gear step N, into the gear step D. If the gear step D is to be currently engaged in the automatic transmission, then in contrast, the gear step N can be engaged by selecting the position B1, or the gear step R can be engaged by selecting the position B2, passing through the gear step N.

In a left-hand shift gate, which corresponds to a manual shift gate, the positions M, T+ and T− are depicted vertically. If the gearshift lever 105 is in the position M, as depicted, then it can be moved by the driver into the position T+, in order to cause an upshifting of the transmission, or in the T− position, in order to cause a downshifting. After releasing it, the gearshift lever 105 normally returns to the position M by means of spring force.

Regardless of the precise arrangement of different positions 110, the control system 100 is configured to bring the gearshift lever 105 into a predetermined position 110, under predetermined conditions, in particular from a position 110 in the manual shift gate, into a position 110 in the automatic shift gate. In the present circumstances, the gearshift lever 105 can be moved, for example, from the position M into the position N, when the motor vehicle is parked. A reset device 115 is provided for the movement, which comprises an electric drive device 120 and an operating element 125, wherein the drive device 120 is configured to operate the operating element 125, in order to move the gearshift lever 105 into the predetermined position 110. Furthermore, the reset device 115 comprises a position sensor 130, which functions according to the inductive measurement principle.

The position sensor 130 comprises a coil 135, which is stationary in relation to the drive device 120, and a magnetic flux element 140, which is stationary in relation to the operating element 125. An activation device 145 is configured to activate the drive device 120 in response to a signal from the position sensor 130. The activation can occur in response to a signal, in particular, which can be received at an interface 150. It is preferred thereby that the coil is attached directly to the activation device 145. In particular, it is preferred that the activation device 145 comprises a printed circuit board, onto which the coil 135 is attached. The coil 135 can be designed, in particular, in the form of a printed circuit, wherein a circuit path made of a conductive material is formed in a plane, in concentric windings. It is also possible to provide numerous coils, which are connected to one another, and are disposed in different planes, above one another, and connected electrically to one another.

The position sensor 130 preferably has the function of a limit switch, which senses in a binary manner whether the operating element 125 has or has not reached a predetermined position. For this, a sensing value can be compared with a threshold value. In other embodiments, a digital position determining using more than two values can also be carried out for the operating element 125. Analog position determinations, i.e. continuous, can also be carried out.

A differential measurement method can be used, in which another coil 160 is provided, the inductivity, or magnetic field, respectively, of which remains unaffected by a position of the flux element 140. The inductivities of the coils 135 and 160 can then be compared with one another, in order to determine, in an analog or digital manner, the position of the flux element 140, and thus the operating element 125. By way of example, two oscillating circuits can be created with the coils 135 and 160, the frequencies of which can be determined and compared with one another.

In a particularly preferred embodiment, another one or more coils 165 can be comprised by the reset device 115, wherein the additional coil 165 can be configured for sensing the position of the gearshift lever 105, for example. For this, the gearshift lever can comprise a flux element, or be mechanically coupled to a flux element. It is particularly preferred that the third coil 165 is directly attached to the activation device 145, in particular as a printed coil on the printed circuit board 155.

FIGS. 2 and 3 show two different mechanical drives, which can be used for transferring a movement of the drive device 120 to the operating element 125. Therein, FIG. 2 shows an exemplary worm gearing, and FIG. 3 shows an exemplary linear drive. In both cases, the drive device 120 comprises an electric motor, which provides a rotational movement. The worm gearing from FIG. 2 supports this movement, and likewise provides a rotational movement, which can be used to reset the gearshift lever 105. The linear drive from FIG. 3 likewise supports the rotational movement of the drive device 120, but provides instead, a linear movement, which can be used to reset the gearshift lever 105. In both cases, an additional gear step can also be used, e.g. in each case between the drive device 120 and the worm. Both of the drives, or types of drives, shown therein can be used with the present disclosure.

FIGS. 4 and 5 show variations of an assembly of a mechanical drive, which provides a rotational movement at the activation device 145 of the reset device 115 from FIG. 1. According to the embodiment in FIG. 4, it can be determined that the operating element 125 has reached a predetermined position when the flux element 140 is located at a limited distance to the coil 135. For this, the flux element 140 is brought within a radius surrounding a rotational axis 405, about which the mechanical drive provides the rotational movement for resetting the gearshift lever 105. In the present illustration, the lever is designed, by way of example, as a cam or an eccentric tappet, which can directly support the operating element 125. In another embodiment, a separate element is provided for supporting the operating element 125.

A complementary embodiment to the embodiment in FIG. 4 is illustrated in FIG. 5. It can be determined here that the operating element 125 has reached a predetermined position when the magnetic flux element 140 is removed from the coil 135, which corresponds to a predetermined rotational position about the rotational axis 405.

In the embodiments in FIGS. 4 and 5, two flux elements can also be provided on different sides of the printed circuit board 155. For this, the lever, the cam, the disk or the eccentric tappet, which retains the flux element 140 in relation to the rotational movement about the rotational axis 405, can be slotted in the plane of rotation, in order to accommodate the printed circuit board 155 in the region of the slot.

It is possible in general to design the magnetic flux element 140 to either amplify or dampen a magnetic field of the first coil 135. An amplification can be obtained, for example, by means of a magnetically soft material, while a damping can be caused by means of a conductive, preferably non-ferromagnetic material such as copper or aluminum. Eddy currents can be formed in the material thereby, by means of the magnetic field, which reduce the magnetic field, or the magnetic flux. In one embodiment, a mechanical element of the reset device 115 is already formed from an appropriate material, such that the element need only be formed in accordance with one of the options in FIG. 4 or 5, in order to be able to carry out a position determination by means of the coil 135. The material can comprise, by way of example, aluminum or zinc die casting. In another embodiment, a magnetic flux element 140 can be attached at an appropriate point to a moving element of the reset device 115.

FIG. 6 shows an alternative to the attachment of the magnetic flux element 150 to a rotatable component of the reset device 115, in which the rotational axis 405 is parallel to a plane into which the activation device 145 extends. The magnetic flux element 140 oriented differently than in the embodiments shown in FIGS. 4 and 5 with regard to the rotational axis 405, such that rather than being oriented axially, it is oriented radially thereto. For this, one or more flux elements 140 may be disposed on the outer surface of a cylindrical component, for example. In another embodiment, a cylindrical component may have one or more axial extensions at a predetermined circumference about the rotational axis 405, onto which the magnetic flux element 140 is attached. The cylindrical component can then resemble a crown, wherein the coil 135 is disposed axially such that it lies in the rotational plane in which one or more extensions lie.

FIG. 7 shows an arrangement of flux elements 140 on a moving element 705, which is mechanically coupled to the operating element 125. The illustrated arrangement can be used alternatively with a moving element 705 that is rotated about the rotational axis 405, or with a moving element that is linearly displaced. Numerous flux elements 140 are attached to the element 705, which can be sensed with numerous coils 135 of the position sensor 130. It is preferred thereby that the coils 135 sense the presence or absence of different magnetic flux elements. In the illustration in FIG. 7, the flux elements are divided into a first track 710 and a second track 715, for example. Each track 710, 715 is assigned to a coil. The coils 135 may be located adjacent to one another in a direction perpendicular to the direction of movement for the moving element 705. A binary encoding of the position of the element 705 can occur. The encoding can support as many bits as there are tracks 710, 715, corresponding to a maximal resolution of 2ⁿ positions for n tracks. With the arrangement shown herein, of two tracks, four different positions of the element 705 can be sensed. In other embodiments, more tracks 710, 715 may be used in order to increase the resolution.

FIG. 8 shows another variation of moving element 705 from FIG. 7, in which only one track 710 is used. In this case, the flux elements 140 are preferably attached at equidistant positions in the direction of movement. As a result, an incremental sensing of the flux element 140 by means of the coil 135 can occur. The flux elements 140 can be as wide as the gaps between them with respect to the direction of movement of the element 705. In order to increase the resolution, two coils 135 may be used thereby, which are offset in the direction of movement by one half of the width of the flux element 140.

FIG. 9 shows another alternative arrangement of flux elements 140 on the moving element 705, analogous to the embodiments in FIGS. 7 and 8. In this case, two flux elements 140 of different types are disposed in the same track 710. While the one flux element causes an amplification of the magnetic field, the other is configured to dampen the magnetic field of the coil 135. The two flux elements 140 are tapered, complementary directions, along the direction of movement of the element 705. Depending on the position of the coil 135 in relation to the element 705, the magnetic field of the coil 135 can be affected in a negative or positive manner, or not at all. As a result, an analog, in particular, sensing of the position of the moving element 705 can be carried out. The analog sensed position can also be made discrete, in order to provide a digital position.

### REFERENCE SYMBOLS

100 Control system
105 Gearshift lever
110 Position of the gearshift lever
115 Reset device
120 Electric drive device
125 Operating element
130 Position sensor
135 First coil
140 Magnetic flux element
145 Activation device
150 Interface
155 Printed circuit board
160 Second coil
165 Third coil
405 Rotational axis
705 Moving element
710 First track
715 Second track

1. A reset device (115) for a gearshift lever (105) for a gear step of a transmission in a motor vehicle, wherein the reset device (115) comprises:
an electric drive device (120) for controlling an operating element (125), in order to move the gearshift lever (105) into a predetermined position;
a position sensor (130) for determining a position of the operating element (125); and
an electric activation device (145) for activating the drive device (120), depending on the position of the operating element (125),
characterized in that
the position sensor (130) comprises a first coil (135), which is attached to the activation device (145),
wherein a magnetic flux element (140) is mechanically coupled to the operating element (125),
wherein the drive device (120) is disposed in relation to the activation device (145), such that the flux element (140) influences the inductivity of the first coil (135), depending on a position of the operating element (125).

2. The reset device (115) according to claim 1, wherein the activation device (145) comprises a printed circuit board (155), and the first coil (135) is formed as a conductive path on the printed circuit board (155).

3. The reset device (115) according to claim 1 or 2, wherein the position sensor (130) comprises a second coil (160), which is attached to the activation device (145) such that its inductivity is not influenced by a position of the operating device (125), wherein the position sensor (130) is configured to determine the position of the operating element (125) based on a difference in the inductivities of the coils (135).

4. The reset device (115) according to claim 2, wherein another position sensor (130) is provided for determining a position of the gearshift lever (105), wherein the other position sensor (130) comprises a third coil (165), the inductivity of which is dependent on the position of the gearshift lever (105), the second coil (160) is not influenced by a position of the gearshift lever (105), and the position of the gearshift lever (105) is determined on the basis of a difference in the inductivities of the second and third coil (165).

5. The reset device (115) according to one of the preceding claims, wherein the flux element (140) comprises a section having a magnetically soft material, in order to amplify a magnetic flux of the magnetic field provided by the first coil (135), when the section is brought into proximity with the first coil (135).

6. The reset device (115) according to one of the preceding claims, wherein the flux element (140) comprises a section having an electrically conductive material, in order to reduce a magnetic flux of the magnetic field provided by the first coil (135), when the section is brought into proximity with the first coil (135).

7. The reset device (115) according to one of the claim 5 or 6, wherein an arrangement of numerous sections having flux elements (140) is provided, wherein the sections are moved past the first coil (135) successively when the operating element is operated, wherein the position of the operating element (125) is determined incrementally, based on a temporal course of inductions at the first coil (135).

8. The reset device (115) according to one of the claim 5 or 6, wherein numerous first coils (135) are provided, wherein an arrangement of numerous sections having flux elements (140) is provided, wherein the arrangement is moved past the first coils (135) when the operating element (125) is operated, wherein the position of the operating element (125) is determined absolutely, based on a combination of inductions of the first coil (135).

9. The reset device (115) according to one of the claims 2 to 8, wherein two flux elements (140) are provided, which lie opposite one another with respect to the printed circuit board (155).

10. The reset device (115) according to one of the claims 2 to 9, wherein two first coils (135) are provided, which lie on opposite planes of the printed circuit board (155).
